(19) United States
(12) Patent Application Publication
(10) Pub. No.: US 2010/0329738 A1
(43) Pub. Date: Dec. 30, 2010

(54) IMAGE FORMING APPARATUS

(75) Inventor: Katsumi SHIRAI, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/825,391

(22) Filed: Jun. 29, 2010

(30) Foreign Application Priority Data
Jun. 30, 2009 (JP) 2009-155372

(51) Int. Cl. G03G 21/00

(52) U.S. Cl. 399/124

(57) ABSTRACT

An image forming apparatus having a feed unit, a door, an in-body sheet feed section and a disposable unit. The feed unit has a component of a sheet path for single-side printing and a component of a sheet path for double-side printing. The door has a component of the sheet path for double-side printing. The in-body sheet feed section has a component of the sheet path for single-side printing, and the disposable unit includes a part of the in-body sheet feed section. The feed unit and the door are capable of pivoting on respective pivot shafts. When the door is closed, the door, the feed unit and the in-body sheet feed section form the sheet path for single-side printing and the sheet path for double-side printing. When the door is open, the disposable unit is attachable to and detachable from the body of the image forming apparatus through the open door, and in accordance with the pivoting state of the door and the pivoting state of the feed unit, the door and the feed unit become a first state wherein the sheet path for single-side printing and the sheet path for double-side printing are open and become a second state wherein the feed unit retreats from the locus of the disposable unit to and from the body of the image forming apparatus.

This application is based on Japanese Patent Application No. 2009-155372 filed on Jun. 30, 2009, of which content is incorporated herein by reference.

### BACKGROUND OF THE INVENTION

1. Field of the Invention

The present invention relates to an image forming apparatus, and more particularly to an image forming apparatus having a side surface that permits access to the inside of the apparatus for treatment of a paper jam or an exchange of disposable units.

2. Description of Related Art

An image forming apparatus, such as an electrophotographic copying machine or a printer, has a door on a side surface so as to permit an operator to make access to the inside of the apparatus for treatment of a paper jam or for attachment/detachment of a disposable unit such as an intermediate transfer unit. Japanese Patent Laid-Open Publication No. 7-219286 (Reference 1) and Japanese Patent Laid-Open Publication No. 2005-70218 (Reference 2) teach that only one door is provided as this type of door so as to ensure the rigidity of the housing of the apparatus body. Japanese Patent Laid-Open Publication No. 2005-138967 (Reference 3) teaches that a door incorporating a sheet path for single-side printing and a sheet path for double-side printing is provided to improve the handleability and the visibility at the time of treating a paper jam.

In image forming apparatuses disclosed by References 1 and 2, when the door for attachment/detachment of a disposable unit to/from the image forming apparatus is opened, only the sheet path for single-side printing becomes open, and the sheet path for double-side printing does not become open. Therefore, when a paper jam occurs in the sheet path for double-side printing, the paper jam cannot be seen and cannot be treated unless another door is open. An image forming apparatus disclosed by Reference 3 is improved in this point, but it is impossible to attach and detach a disposable unit to and from the apparatus body through the door. In the apparatus disclosed by Reference 3, two doors, one of which is for treatment of a paper jam and the other of which is for an exchange of disposable units, are provided to the housing of the apparatus body. The arrangement of two doors makes it difficult to ensure sufficient rigidity for the apparatus body.

### SUMMARY OF THE INVENTION

An object of the present invention is to provide an image forming apparatus that facilitates treatment of a paper jam and an exchange of disposable units without lowering the rigidity of the apparatus body.

According to an aspect of the present invention, an image forming apparatus comprises: a feed unit comprising, on a first side, a component of a sheet path for single-side printing and, on a second side that is opposite to the first side, a component of a sheet path for double-side printing; a door comprising, on an inner side that faces the second side of the feed unit, a component of the sheet path for double-side printing; an in-body sheet feed section comprising, in a position to face the first side of the feed unit, a component of the sheet path for single-side printing; and a disposable unit that is attachable to and detachable from a body of the image forming apparatus, the disposable unit comprising a part of the in-body sheet feed section. In the image forming apparatus, the feed unit is capable of pivoting on a pivot shaft, and the door is capable of pivoting on a pivot shaft. When the door is closed, the door, the feed unit and the in-body feed section form the sheet path for single-side printing and the sheet path for double-side printing, and when the door is open, the disposable unit is attachable to and detachable from the body of the image forming apparatus through the open door. When the door is open, in accordance with a pivoting state of the door and a pivoting state of the feed unit, the door and the feed unit become a first state wherein the sheet path for single-side printing and the sheet path for double-side printing formed by the door, the feed unit and the in-body sheet feed section are open and become a second state wherein the feed unit retreats from a locus of the disposable unit to and from the body of the image forming apparatus.

### BRIEF DESCRIPTION OF THE DRAWINGS

This and other objects and features of the present invention will be apparent from the following description with reference to the accompanying drawings, in which:

FIG. 1 is a schematic view of an image forming apparatus according to a first embodiment of the present invention;

FIG. 2 is a schematic view of the image forming apparatus according to the first embodiment, showing a state wherein a door is open;

FIG. 3 is a perspective view showing the appearance of the image forming apparatus according to the first embodiment;

FIG. 4 is a perspective view showing the appearance of the image forming apparatus according to the first embodiment, showing a state wherein a door is open;

FIG. 5 is a perspective view showing attachment/detachment of an intermediate transfer unit to/from the image forming apparatus according to the first embodiment;

FIG. 6 is a schematic view of an image forming apparatus according to a second embodiment of the present invention, showing a state wherein a door is open;

FIG. 7 is a perspective view showing the appearance of the image forming apparatus according to the second embodiment;

FIG. 8 is a perspective view of the image forming apparatus according to the second embodiment of the present invention, showing a state wherein a door is open;

FIG. 9 is a schematic view showing attachment/detachment of an intermediate transfer unit to/from of the image forming apparatus according to the second embodiment;

FIG. 10 is a perspective view showing attachment/detachment of an intermediate transfer unit to/from of the image forming apparatus according to the second embodiment;

FIGS. 11a and 11b are plan views showing a space for the image forming apparatus according to the first embodiment and a space for the image forming apparatus according to the second embodiment, respectively;

FIG. 12 is a schematic view of an image forming apparatus according to a third embodiment, showing a state wherein a door is open;

FIG. 13 is a perspective view showing the appearance of the image forming apparatus according to the third embodiment;

FIG. 14 is a perspective view of the image forming apparatus according to the third embodiment, showing a state wherein a door is open;

FIG. 15 is a schematic view showing attachment/detachment of an intermediate transfer unit to/from the image forming apparatus according to the third embodiment;

FIG. 16 is a perspective view of the image forming apparatus according to the third embodiment, showing a state wherein a door is open;

FIG. 17 is a perspective view showing attachment/detachment of an intermediate transfer unit to/from the image forming apparatus according to the third embodiment;

FIG. 18 is a perspective view of an image forming apparatus according to a fourth embodiment, showing a state wherein a door is open;

FIG. 19 is a perspective view of the image forming apparatus according to the fourth embodiment, showing a state wherein the door is open; and

FIG. 20 is a perspective view showing attachment/detachment of an intermediate transfer unit to/from the image forming apparatus according to the fourth embodiment.

### DETAILED DESCRIPTION OF THE PREFERRED EMBODIMENTS

Image forming apparatuses according to embodiments of the present invention are described with reference to the accompanying drawings. In the drawings, the same parts and members are provided with the same reference symbols, and repetitions of descriptions thereof are omitted.

### First Embodiment

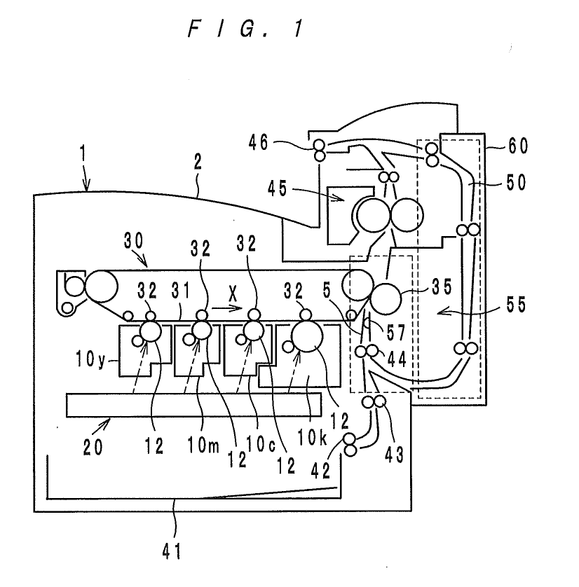

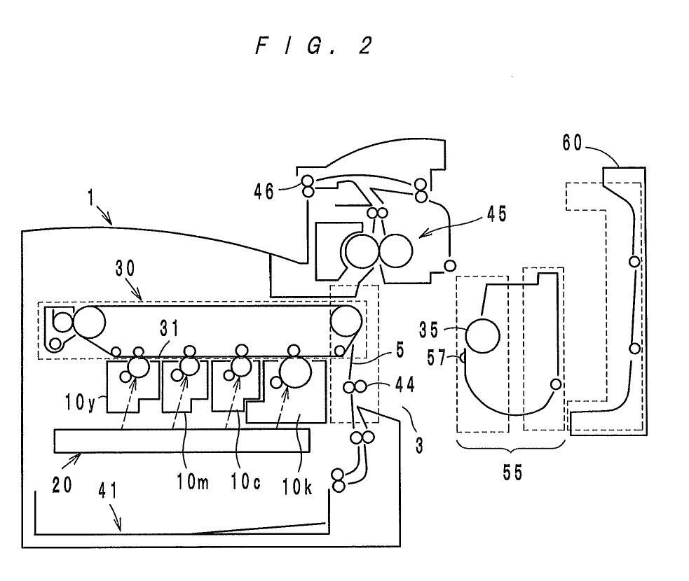

### See FIGS. 1-5

Referring to FIGS. 1-5, an image forming apparatus according to a first embodiment of the present invention is described. As shown by FIG. 1, this image forming apparatus is a tandem type color printer, and mainly comprises process units 10 (10y, 10m, 10c and 10k) for forming toner images of yellow, magenta, cyan and black respectively, a laser scanning unit 20 and an intermediate transfer unit 30.

Each of the process units 10 comprises, in a housing, a photosensitive drum 12, a charging roller, a developing device, a residual toner/charge cleaner, etc., which are not shown in the drawings, and is capable of sliding in a direction perpendicular to the paper surface of FIG. 1 so as to be detachable from the body of the printer. In each of the process units 10, an electrostatic latent image is formed on the photosensitive drum 12 by laser radiation from the laser scanning unit 20, and the electrostatic latent image is developed into a toner image.

The intermediate transfer unit 30 has an intermediate transfer belt 31 that is an endless belt driven to rotate in a direction “X”. Electric fields are formed by transfer rollers 32 located opposite to the respective photosensitive drums 12, and thereby, the toner images formed on the photosensitive drums 12 are transferred to the intermediate transfer belt 31 and combined thereon (first transfer). Such an electrophotographic image forming process is well known, and a detailed description thereof is omitted.

An automatic sheet feed unit 41 for feeding sheets one by one is provided in a lower part of the printer body. Each sheet is fed from a pair of feed-out rollers 42 to a pair of timing rollers 44 via a pair of feed rollers 43 and then, fed to a nip portion between the intermediate transfer belt 31 and a second transfer roller 35, where the toner image (the color composite image) is transferred to the sheet (second transfer). Thereafter, the sheet is fed to a fixing unit 45, where a heating treatment is performed, and is ejected on a tray 46 located on an upper surface of the printer body.

In double-side printing operation for performing printing on both sides of a sheet, after a sheet is printed and heated on its first side, the sheet makes a switchback by reverse rotation of ejection rollers 46. Then, the sheet is fed downward in a sheet path for double-side printing 50 back to the timing rollers 44. Thereafter, the sheet is printed and heated on its second side and is ejected through the ejection rollers 46.

A feed unit 55 that integrally holds the second transfer roller 35 therein is provided, and as will be described later, the feed unit 55 is opened and closed together with the door 60. The feed unit 55 has, on a first side (left side in FIG. 1), guide plates that are components of a sheet path for single-side printing and has, on a second side (right side in FIG. 1) opposite to the first side, guide plates that are components of the sheet path for double-side printing 50. The door 60 has, on an inner surface facing the second side of the feed unit 55, guide plates that are components of the sheet path for double-side printing 50. In the apparatus body 1, an in-body sheet feed section comprising guide plates that are components of the sheet path for single-side printing is disposed such that the guide plates face the first side of the feed unit 55.

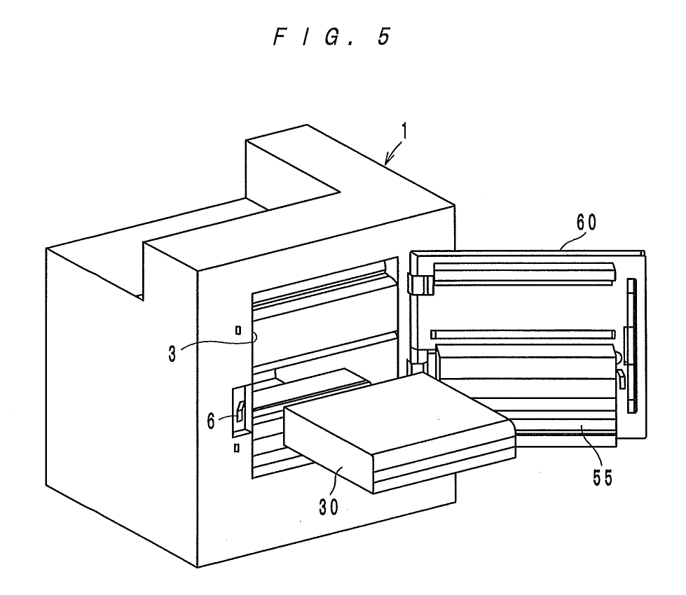

The intermediate transfer unit 30 is attachable to and detachable from the apparatus body 1. The attachment/detachment of the intermediate transfer unit 30 will be described later, referring to FIG. 5.

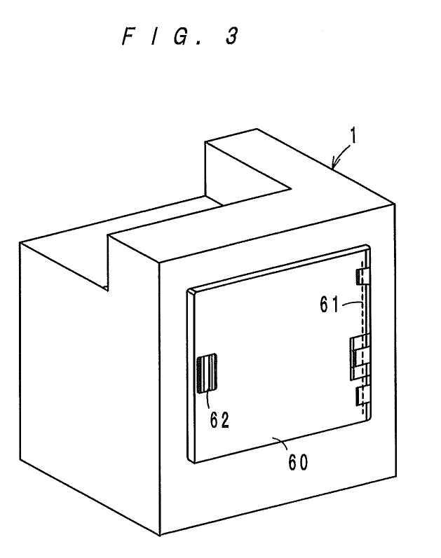

As shown by FIG. 3, the door 60 is disposed in an opening 3 made in a side surface of the apparatus body 1 such that the door 60 is capable of pivoting horizontally on a shaft 61. The shaft 61 is located in the rear side of the apparatus body 1 such that the shaft 61 extends in a sheet feeding direction (a direction vertical to the floor). Also, the feed unit 55 is fitted to the apparatus body 1 such that the feed unit 55 is capable of pivoting on the shaft 61. The door 60 and the feed unit 55 are capable of pivoting on the shaft 61 independently of each other.

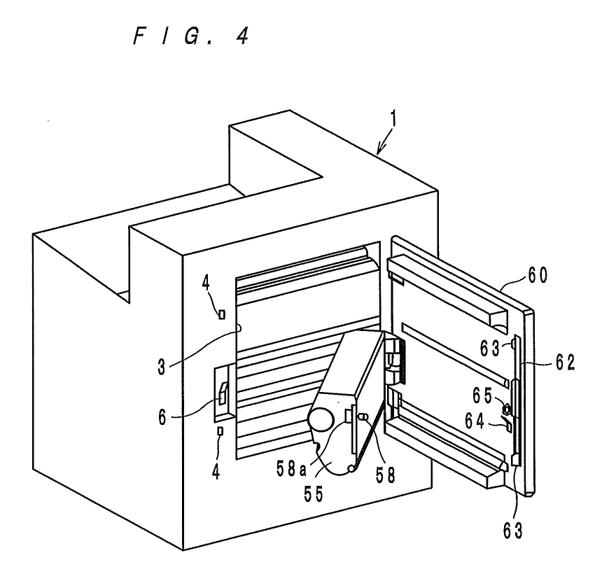

As shown by FIG. 4, the door 60 further has a lever 62 for permitting an operator to open and close the door 60, a hook 63 working with the lever 62, and a spring 64 for pressing the feed unit 55. A lock 4 that is capable of engaging with the hook 63 is provided in the apparatus body 1. The lever 62, the hook 63 and the lock 4 are known as components of an open/close/lock mechanism of this type of door 60.

While the door 60 is closed, the hook 63 engages with the lock 4, and the spring 64 presses the feed unit 55 on the second side elastically. In this state, a contact portion 57 of the feed unit 55 abuts against a positioning plate 5 of the in-body sheet feed section (see FIG. 1). Thereby, the door 60 and the feed unit 55 are held in specified proper positions relative to the in-body sheet feed section, and thus, adequate sheet paths can be formed.

The apparatus body 1 has a spring 6 (see FIG. 4) in a position to face the pivotable end of the feed unit 55. The force of the spring 6 is smaller than the force of the spring 64 so that the contact portion 57 of the feed unit 55 can keep in contact with the positioning plate 5 while the door 60 is closed. While the door 60 is closed, the feed unit 55 is also pressed elastically by the spring 6 in a direction to open the door 60. Therefore, when the lever 62 is operated to open the door 60, the hook 63 is released from the lock 4, and the door 60 opens. In this moment, the feed unit 55 separates from the in-body sheet feed section, and the sheet path for single-side printing becomes open. Concurrently, the feed unit 55 is pressed by the spring 64 and separates from the door 60, and thereby, the sheet path for double-side printing becomes open.

The intermediate transfer unit 30 is exchangeable as a whole, and while the opening 3 of the apparatus body 1, that is, the door 60 is open, the intermediate transfer unit 30 is attachable to and detachable from the apparatus body 1. FIG. 5 shows a state (second state) wherein the door 60 is open wider than the state shown by FIG. 4 and wherein the feed unit 55 comes close to the door 60 to retreat from the locus of the intermediate transfer unit 30 to and from the apparatus body 1. In order to permit fixture of the feed unit 55 to the door 60 at this time, the feed unit 55 has a spring 58 with a dial 58a, and the door 60 has a nut 65.

As described above, by taking only one action, that is, operating the lever 62 to open the door 60, the door 60 and the feed unit 55 pivot open and become the first state shown by FIG. 4, wherein the sheet path for single-side printing and the sheet path for double-side printing are open. In this state, the handleability and the visibility for treating a paper jam are good. Also, by putting the door 60 and the feed unit 55 into the second state shown by FIG. 5, wherein the door 60 and the feed unit 55 retreat from the locus of the intermediate transfer unit 30 to and from the apparatus body 1, an operator can attach and detach the intermediate transfer unit 30 to and from the apparatus body 1. Thus, treatment of a paper jam and attachment/detachment of the intermediate transfer unit 30 can be performed through the opening 3. Therefore, it is necessary to make only one opening 3 in the apparatus body 1, and the rigidity of the apparatus body 1 can be maintained.

### Second Embodiment

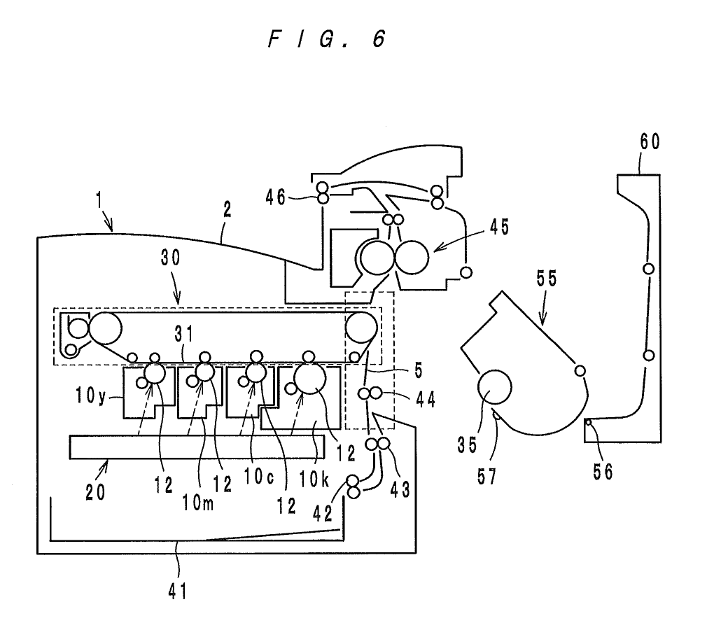

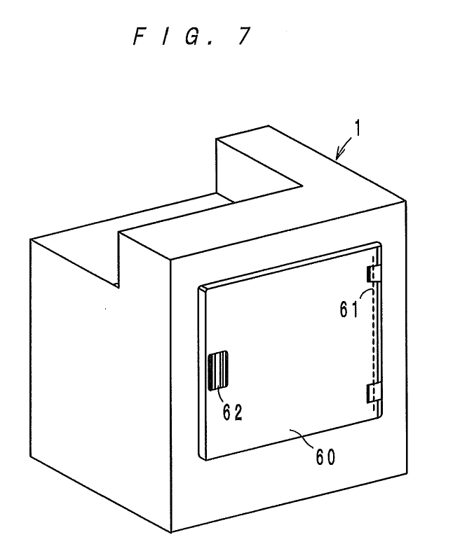

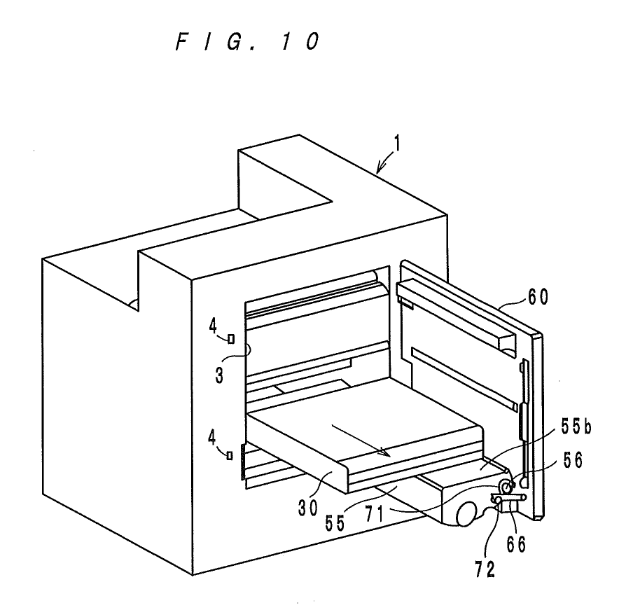

### See FIGS. 6-10

An image forming apparatus according to a second embodiment is basically of the same structure as the image forming apparatus according to the first embodiment. The difference of the second embodiment from the first embodiment is that a pivot shaft 56 of the feed unit 55 is disposed in the door 60 so as to extend in a direction perpendicular to the sheet feeding direction.

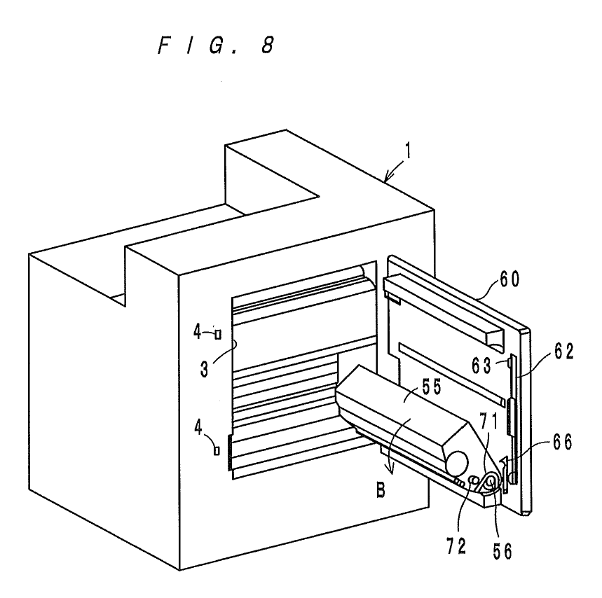

As shown by FIG. 8, a spring 71 is fitted to the pivot shaft 56 of the feed unit 55. The spring 71 forces the feed unit 55 such that the contact portion 57 of the feed unit 55 is pressed against the positioning plate 5 while the door 60 is closed. When the door 60 is opened, the feed unit 55 is falling down in the direction “B” in FIG. 8 by its own weight, whereas the spring 71 presses back the feed unit 55. Accordingly, the feed unit 55 pivots on the shaft 56 in the direction “B” until the weight of the feed unit 55 is balanced with the force of the spring 71. Thus, as in the first embodiment, by taking one action, that is, operating the lever 62, the door 60 opens, and simultaneously, the feed unit 55 pivots. Thereby, the door 60 and the feed unit 55 become the first state shown by FIG. 8, wherein the sheet path for single-side printing and the sheet path for double-side printing are open.

Also, in order to keep the feed unit 55 in a position (second state) to retreat from the locus of the intermediate transfer unit 30, a pin 72 is disposed on the feed unit 55, and a hook 66 is disposed on the door 60. Thereby, the feed unit 55 can be fixed to the door 60. By pressing the feed unit 55 down from the position shown in FIG. 8 against the force of the spring 71, an operator can engage the pin 72 with the hook 66, and thereby, the feed unit 55 can be kept in a position immediately under the locus of the intermediate transfer unit 30.

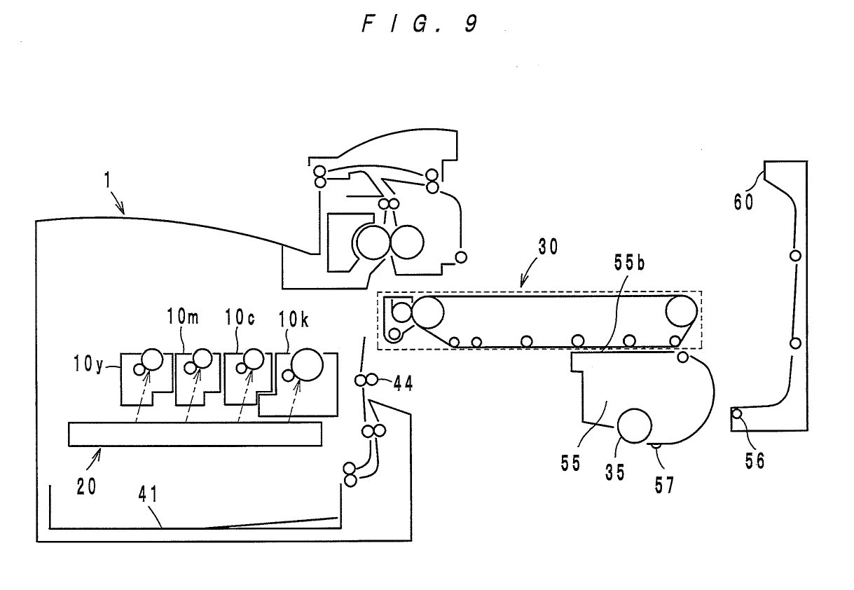

In this way, the feed unit 55 is kept in a horizontal posture (second state) as shown by FIG. 9, and the intermediate transfer unit 30 is attached to and detached from the apparatus body 1, guided by a second surface 55b of the feed unit 55. Thus, the second surface 55b of the feed unit 55 serves as a guide member for attachment/detachment of the intermediate transfer unit 30, and therefore, the handleability for attachment/detachment of the intermediate transfer unit 30 is improved.

The image forming apparatus according to the second embodiment has the same advantages of the image forming apparatus according to the first embodiment. In the second embodiment, further, an advantage that the image forming apparatus occupies a smaller space can be obtained. This advantage will be described below.

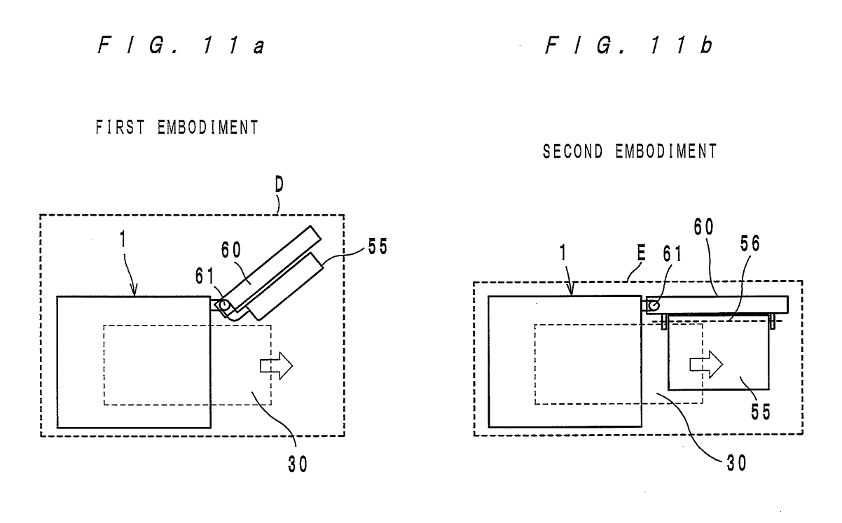

### Occupation Space; See FIG. 11

In the first embodiment and in the second embodiment, the door 60 pivots on the vertical shaft 61. With respect to the feed unit 55, in the first embodiment, the feed unit 55 pivots on the same shaft 61 in the same direction as the door 60, whereas in the second embodiment, the feed unit 55 pivots up and down (in the direction perpendicular to the pivot direction of the door 60) on the horizontal shaft 56.

In the first embodiment, in order to attach and detach the intermediate transfer unit 30 to and from the apparatus body 1, it is necessary to open the door 60 wide as shown by FIG. 11a. Therefore, as shown by the dotted line “D” in FIG. 11a, a relatively large space is necessary for the image forming apparatus according to the first embodiment. In the second embodiment, on the other hand, it is only necessary to open the door 60 at about 90 degrees as shown by FIG. 11b. Therefore, as shown by the dotted line “E” in FIG. 11b, a smaller space is necessary for the image forming apparatus according to the second embodiment.

### Third Embodiment

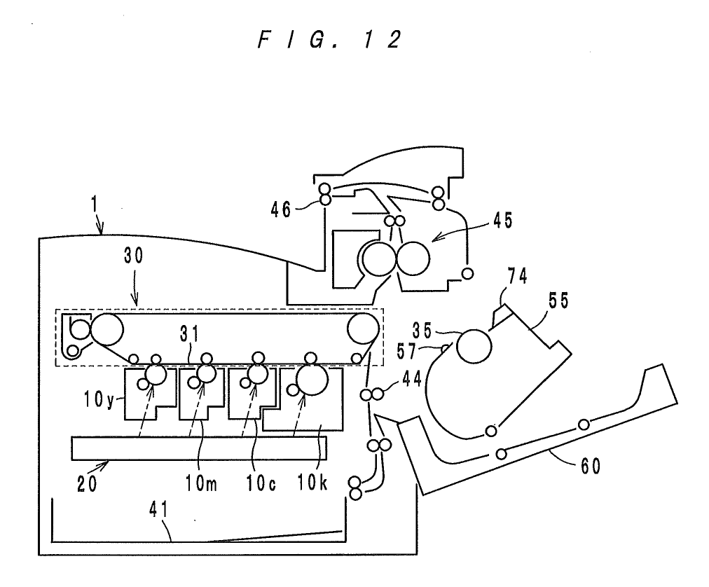

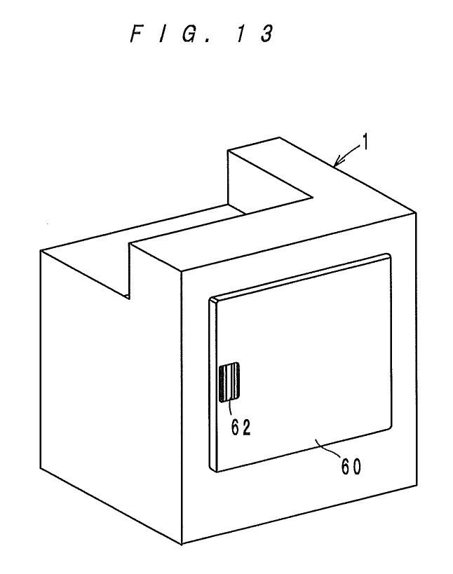

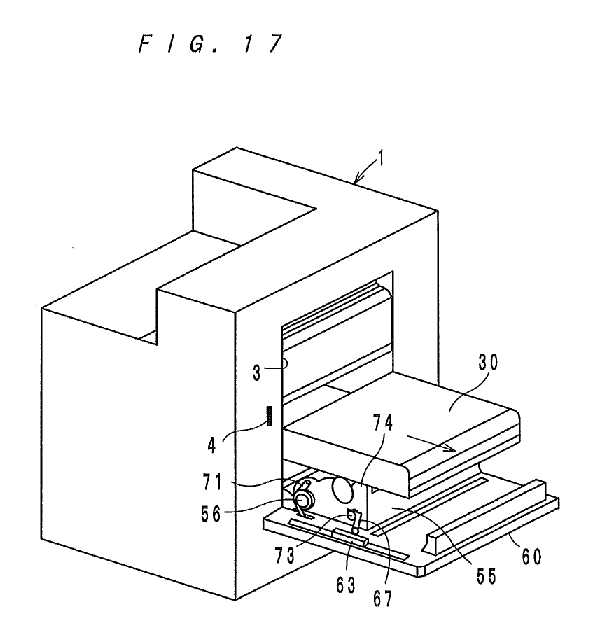

### See FIGS. 12-17

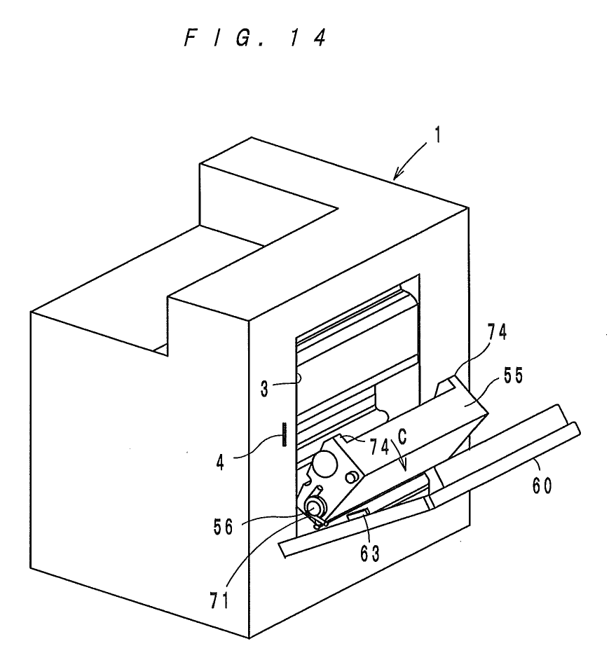

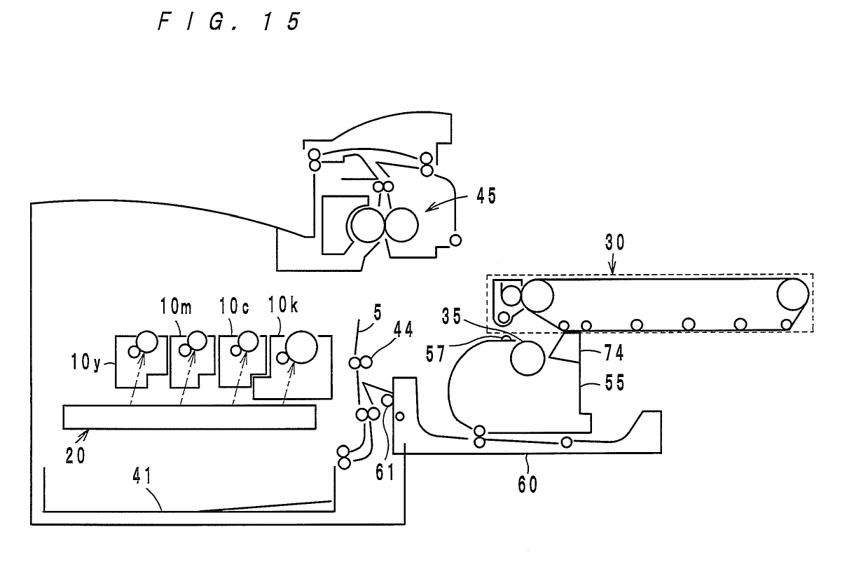

An image forming apparatus according to a third embodiment is basically of the same structure as the first embodiment. The differences of the third embodiment from the first embodiment are that the pivot shaft 61 (see FIG. 15) of the door 60 is disposed to extend in a direction perpendicular to the sheet feeding direction and that a pivot shaft 56 (see FIG. 14) of the feed unit 55 is disposed on the door 60 to extend in the direction perpendicular to the sheet feeding direction.

The door 60 is capable of pivoting up and down on the horizontal shaft 61, and the feed unit 55 is capable of pivoting up and down on the shaft 56. A spring 71 is provided to the pivot shaft 56 of the feed unit 55. The spring 71 forces the feed unit 55 such that the contact portion 57 of the feed unit 55 is pressed against the positioning plate 5 while the door 60 is closed. When the door 60 is opened, the feed unit 55 is falling down in the direction “C” in FIG. 14 by its own weight, whereas the spring 71 presses back the feed unit 55. Accordingly, the feed unit 55 pivots on the shaft 56 in the direction “C” until the weight of the feed unit 55 is balanced with the force of the spring 71. Thus, as in the first embodiment, by taking one action, that is, operating the lever 62, the door 60 and the feed unit 55 pivot open and become the first state shown by FIGS. 12 and 14, wherein the sheet path for single-side printing and the sheet path for double-side printing are open.

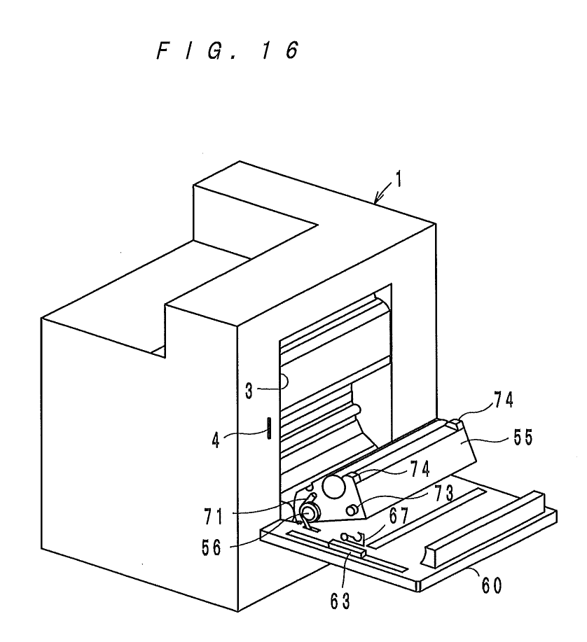

Also, in order to keep the feed unit 55 in a position to retreat from the locus of the intermediate transfer unit 30, a pin 73 is disposed on the feed unit 55, and a hook 67 is disposed on the door 60. Thereby, the feed unit 55 can be fixed to the door 60. By pressing the feed unit 55 down from the position shown in FIG. 16 against the force of the spring 71, an operator can engage the pin 73 with the hook 67, and thereby, the feed unit 55 can be kept in a position immediately under the locus of the intermediate transfer unit 30.

In this way, the feed unit 55 is kept in a horizontal posture (second state) as shown by FIG. 15, and the intermediate transfer unit 30 is attached to and detached from the apparatus body 1, guided by projections 74 of the feed unit 55. Thus, the projections 74 of the feed unit 55 serve as guide members for attachment/detachment of the intermediate transfer unit 30, and therefore, the handleability of attachment/detachment of the intermediate transfer unit 30 is improved.

The image forming apparatus according to the third embodiment has the same advantages of the image forming apparatus according to the first embodiment. Like the apparatus according to the second embodiment, the image forming apparatus according to the third embodiment further has the advantage that the apparatus occupies a small space.

### Fourth Embodiment

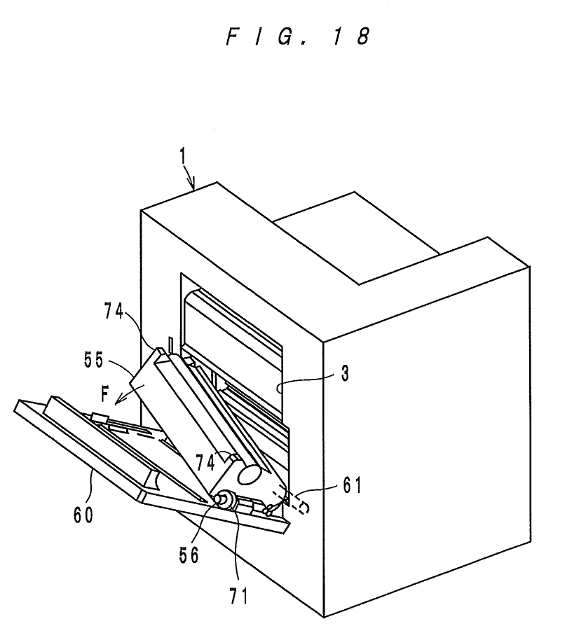

### See FIGS. 18-20

An image forming apparatus according to a fourth embodiment is basically of the same structure as the first embodiment. The differences of the fourth embodiment from the first embodiment are that the pivot shaft 61 of the door 60 is disposed to extend in a direction perpendicular to the sheet feeding direction (as in the third embodiment) and that a pivot shaft 56 of the feed unit 55 is disposed on the door 60 to extend in the sheet feeding direction (perpendicularly to the shaft 61).

The door 60 pivots up and down on the horizontal shaft 61, and the feed unit 55 pivots up and down on the shaft 56. A spring 71 is provided to the pivot shaft 56 of the feed unit 55. The spring 71 forces the feed unit 55 such that the contact portion 57 of the feed unit 55 is pressed against the positioning plate 5 while the door 60 is closed. When the door 60 is opened, the feed unit 55 is falling down in the direction “F” in FIG. 18 by its own weight, whereas the spring 71 presses back the feed unit 55. Accordingly, the feed unit 55 pivots on the shaft 56 in the direction “F” until the weight of the feed unit 55 is balanced with the force of the spring 71. Thus, as in the first embodiment, by taking one action, that is, operating the lever 62, the door 60 opens, and simultaneously, the feed unit 55 pivots. Thereby, the door 60 and the feed unit 55 become the first state shown by FIG. 18, wherein the sheet path for single-side printing and the sheet path for double-side printing are open.

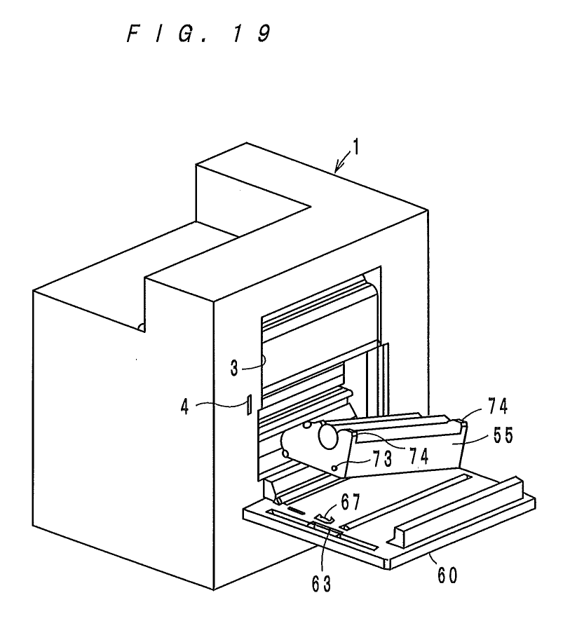

Also, in order to keep the feed unit 55 in a position to retreat from the locus of the intermediate transfer unit 30, a pin 73 is disposed on the feed unit 55, and a hook 67 is disposed on the door 60. Thereby, the feed unit 55 can be fixed to the door 60. By pressing the feed unit 55 down from the position shown in FIG. 19 against the force of the spring 71, an operator can engage the pin 73 with the hook 67, and thereby, the feed unit 55 can be kept in a position immediately under the locus of the intermediate transfer unit 30.

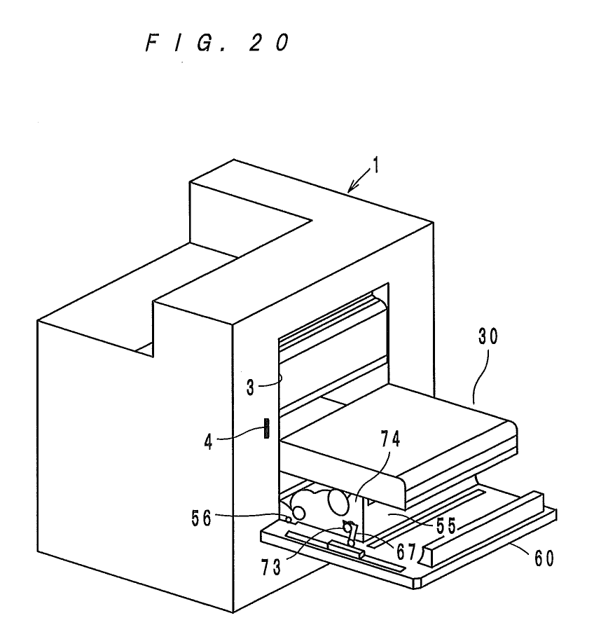

In this way, the feed unit 55 is kept in a horizontal posture (second state) as shown by FIG. 20, and the intermediate transfer unit 30 is attached to and detached from the apparatus body 1, guided by projections 74 of the feed unit 55. Thus, the projections 74 of the feed unit 55 serve as guide members for attachment/detachment of the intermediate transfer unit 30, and therefore, the handleability for attachment/detachment of the intermediate transfer unit 30 is improved.

The image forming apparatus according to the fourth embodiment has the same advantages of the image forming apparatus according to the first embodiment. Like the apparatus according to the second embodiment, the image forming apparatus according to the fourth embodiment further has the advantage that the apparatus occupies a small space.

### Other Embodiments

The details of the door, the feed unit and the sheet paths may be arbitrarily designed. In order to fix the feed unit to the door for attachment/detachment of the intermediate transfer unit, any other types of mechanisms as well as the above-described type can be used. For example, a magnet may be used.

Although the present invention has been described in connection with the preferred embodiments above, it is to be noted that various changes and modifications are to be understood as being within the scope of the present invention.

What is claimed is:

1. An image forming apparatus comprising:
a feed unit comprising, on a first side, a component of a sheet path for single-side printing and, on a second side that is opposite to the first side, a component of a sheet path for double-side printing;
a door comprising, on an inner side that faces the second side of the feed unit, a component of the sheet path for double-side printing;
an in-body sheet feed section comprising, in a position to face the first side of the feed unit, a component of the sheet path for single-side printing; and
a disposable unit that is attachable to and detachable from a body of the image forming apparatus, the disposable unit comprising a part of the in-body sheet feed section,
wherein the feed unit is capable of pivoting on a pivot shaft, and the door is capable of pivoting on a pivot shaft;
wherein when the door is closed, the door, the feed unit and the in-body feed section form the sheet path for single-side printing and the sheet path for double-side printing;
wherein when the door is open, the disposable unit is attachable to and detachable from the body of the image forming apparatus through the open door; and
wherein when the door is open, in accordance with a pivoting state of the door and a pivoting state of the feed unit, the door and the feed unit become a first state wherein the sheet path for single-side printing and the sheet path for double-side printing formed by the door, the feed unit and the in-body sheet feed section are open and become a second state wherein the feed unit retreats from a locus of the disposable unit to and from the body of the image forming apparatus.

2. An image forming apparatus according to claim 1,
wherein a sheet feeding direction in which a sheet is fed through the sheet path for single-side printing and the sheet path for double-side printing is a vertical direction.

3. An image forming apparatus according to claim 1,
wherein the pivot shaft of the door and the pivot shaft of the feed unit are disposed in the body of the image forming apparatus; and
wherein when the door is closed, the door presses the feed unit against the in-body sheet feed section, so that the door and the feed unit can be held in specified positions relative to the in-body sheet feed section.

4. An image forming apparatus according to claim 1,
wherein the pivot shaft of the door and the pivot shaft of the feed unit extend parallel to a sheet feeding direction in which a sheet is fed through the sheet path for single-side printing and the sheet path for double-side printing.

5. An image forming apparatus according to claim 3,
wherein the pivot shaft of the door and the pivot shaft of the feed unit extend parallel to a sheet feeding direction in which a sheet is fed through the sheet path for single-side printing and the sheet path for double-side printing.

6. An image forming apparatus according to claim 1,
wherein the pivot shaft of the door is disposed in the body of the image forming apparatus, and the pivot shaft of the feed unit is disposed in the door; and
wherein when the door is closed, the door presses the feed unit against the in-body sheet feed section, so that the door and the feed unit can be held in specified positions relative to the in-body sheet feed section.

7. An image forming apparatus according to claim 6,
wherein the pivot shaft of the door extends parallel to a sheet feeding direction in which a sheet is fed through the sheet path for single-side printing and the sheet path for double-side printing, and the pivot shaft of the feed unit extends perpendicularly to the sheet feeding direction.

8. An image forming apparatus according to claim 6,
wherein the pivot shaft of the door and the pivot shaft of the feed unit extend perpendicularly to a sheet feeding direction in which a sheet is fed through the sheet path for single-side printing and the sheet path for double-side printing.

9. An image forming apparatus according to claim 6,
wherein the pivot shaft of the door extends perpendicularly to a sheet feeding direction in which a sheet is fed through the sheet path for single-side printing and the sheet path for double-side printing, and the pivot shaft of the feed unit extends parallel to the sheet feed direction.

10. An image forming apparatus according to claim 1,
wherein when the door is closed, the feed unit is pressed by the in-body sheet feed section or by the body of the image forming apparatus in a direction to open the door, so that the feed unit separates from the in-body sheet feed section when the door is opened.

11. An image forming apparatus according to claim 1,
further comprising a connector for fixing the feed unit to the door to keep the feed unit and the door in the second state.

12. An image forming apparatus according to claim 1,
wherein the feed unit comprises a guide for, when the feed unit is in the second state, guiding the disposable unit to be attached to and detached from the body of the image forming apparatus.
